(19) United States
(12) Patent Application Publication
(10) Pub. No.: US 2020/0207203 A1
(43) Pub. Date: Jul. 2, 2020

(54) LOCKING DEVICE FOR FUELLING OR CHARGING RECESS, AND FUELLING OR CHARGING RECESS

(71) Applicants: DR. SCHNEIDER KUNSTSTOFFWERKE GMBH, Kronach (DE); CEBI ITALY S.P. A. ANCONA, Osimo Stazione (IT)

(72) Inventor: Stephan WERNER, Burgkunstadt (DE)

(73) Assignees: DR. SCHNEIDER KUNSTSTOFFWERKE GMBH, Kronach (DE); CEBI ITALY S.P. A. ANCONA, Osimo Stazione (IT)

(21) Appl. No.: 16/631,263

(22) PCT Filed: Jul. 11, 2018
(86) PCT No.: PCT/EP2018/068791

§ 371 Date: Jan. 15, 2020

(30) Foreign Application Priority Data
Jul. 19, 2017 (DE) 10 2017 116 230.5

(51) Int. Cl. B60K 15/05; E05B 83/34; E05B 77/36; E05C 5/02

(52) U.S. Cl. CPC B60K 15/05; E05B 83/34; B60K 2015/0584; E05C 5/02; E05Y 2900/534; E05B 77/36

(57) ABSTRACT

The invention describes a locking device for a fuelling or charging recess, and a fuelling or charging recess, wherein the locking device has a locking pin (12) that has a locking section (14) on one end and can be translationally and rotationally moved for locking. The locking pin (12) has, on the locking section (14), a first holder (16) in which a pressure piece (20) is received that provides a tolerance compensation over the long term. A fuelling or charging recess having a locking device (10) of this kind further has a recess body, a lever arm and a tank filling pipe or charging module, wherein in an opening of the recess body, a tank filling pipe or charging module is inserted and the lever arm is pivotally mounted. The locking device (10) is arranged such that in the closed state of the fuelling or charging recess, a ball (26) or pressure pin of the pressure piece (20) is at least partially pressed by means of the lever arm into the second holder (22) of the pressure piece (20) against the force of a spring (24).

A locking device for fueling or charging recesses and a fueling or charging recess are described, the locking device having a locking pin which has a locking section at one end and can be moved translationally and rotationally for locking purposes.

A locking pin is frequently also called a peg or a locking peg in the relevant technical field. Therefore, the terms locking pin and locking peg can be used as synonyms, and denote identical parts in the following text.

Locking devices of this type are often a constituent part of a central locking unit for fueling and charging recesses. The locking pin or peg can have a groove which is configured in such a way that, in the case of a movement of the locking pin, the latter is rotated. Accordingly, the locking section is rotated, and a lever arm is released which is subsequently pivoted or can be pivoted. The action of the locking pin can take place by means of a spring or what is known as a “push-push” mechanism or electrically. The releasing of the translational and the rotational movement of the locking peg can also take place electrically, the locking pin subsequently being pressed to the outside via the spring, and being rotated and moved on account of the guide groove. The rotating of the locking pin and of the locking section brings about releasing of a lever arm which is subsequently pivoted. In order to close the fueling or charging recess again, the lever arm can be pivoted back and pressed against the locking pin. Rotating of the locking pin likewise occurs here, which locking pin is additionally rotated counter to the force of the spring in the case of its longitudinal movement. The rotating brings it about that a latching device on the lever arm is engaged behind.

After the locking pin has assumed a defined position, a guide element can engage behind a section of the guide groove, for example, with the result that the locking pin is received in its latched position and the lever arm is locked.

The lever arm can have a cover or can be configured as a filler cap. In order that automatic opening of the lever arm takes place after the releasing via the locking pin, the lever arm can be stressed in the locked and closed position via a further spring.

### PRIOR ART

Various locking devices of this type for fueling or charging recesses are known from the prior art. In the case of fueling or charging recesses of this type, it can occur, on account of the tolerances of the various constituent parts, that the lever arm is held with play in the closed position via a locking device. Rattling can therefore occur during driving, which is undesired.

Frequent actuating of the locking device and opening of the fueling or charging recess can further worsen said state.

In order to provide a tolerance compensation with respect to the lever arm interface in the case of fueling or charging modules of this type, it has already been specified to arrange a mushroom-shaped soft component on an end section of a locking pin. As a result of the translational and rotational movement of the locking pin upon actuation of the locking device, pronounced wear of the soft component occurs. A tolerance compensation can therefore no longer be ensured, and a filler flap can rattle during driving operation. In particular in the case of vehicles which have a charging socket, wear occurs within a relatively short time and therefore a tolerance compensation no longer occurs, since there is an increased actuating cycle here.

On account of the rotating and the linear movement of the locking pin upon actuation, all of the tolerance compensation apparatuses which are known from the prior art are subject to high wear. In particular, elements made from a relatively soft material are subject to wear within a short time.

A tolerance compensation therefore cannot be provided for a long time period with a substantially constant tolerance compensation by way of the devices which are known from the prior art. In the case of frequent actuation, in particular, wear occurs within a relatively short time, and a tolerance compensation can no longer be provided.

DE 101 48 199 A1 discloses, for example, a typical actuating apparatus for covering a vehicle body opening of a motor vehicle with a locking journal which can be moved rotationally and translationally. A pressure piece which is of rigid configuration and has a spherical shape is arranged at the upper end of the locking journal. The pressure piece lies via a collar on the locking journal. The shape of the pressure piece provides a small supporting face.

### Problem

In contrast, the problem consists in specifying a locking device for fueling or charging recesses, and a fueling or charging recess, the problems of the prior art being eliminated and a tolerance compensation being ensured over a long actuating time period, even in the case of frequent actuation.

### Solution

The abovementioned problem is solved by way of a locking device for fueling or charging recesses, which locking device has a locking pin, which locking pin has a locking section at one end and can be moved translationally and rotationally for locking purposes, the locking pin having a pressure piece on the locking section, and the pressure piece having a second receptacle, in which a spring and a ball or a pressure pin are arranged, and the ball or the pressure pin are pressed via the spring against an opening of the second receptacle of the pressure piece.

A pressure piece can provide a tolerance compensation in a simple way, since, for example, a lever arm can be pressed via the pressure piece into a position, even in the case of frequent actuation. In addition, wear as in the case of soft components from the prior art does not occur in the case of a pressure piece. This therefore also ensures for a long time and in the case of frequent actuation that the tolerance compensation is maintained.

The pressure piece has a second receptacle, in which a spring and a ball or a pressure pin are arranged, the ball or the pressure pin being pressed via the spring against an opening of the second receptacle of the pressure piece. Pressure pieces are known in various embodiments from the prior art. For example, the pressure piece of the locking device can have a pressure pin. In a further embodiment, the pressure piece of the locking device has a ball. A ball affords the advantage that no abrasion can occur even in the case of a rotational movement of the locking section. The ball is held securely within the second receptacle via the opening, but can be rotated in all directions. This prevents the ball being damaged, even in the case of a rotational movement. The pressure piece is subject to substantially no signs of wear.

In the open state of a filler flap of a fueling or charging module, the ball or the pressure pin is pressed via the spring against the opening, the ball or the pressure pin protruding out of the opening by a definable amount. In the closed state of the filler flap, the latter then presses via the lever arm against the pressure pin or the ball, the ball or the pressure pin being pressed at least in sections into the second receptacle counter to the force of the spring. The spring is stressed in all states, and therefore prevents rattling of the filler flap by way of the tolerance compensation which is provided via this.

The locking pin can have a first receptacle on the locking section, in which first receptacle the pressure piece is received.

The pressure piece can therefore be subsequently inserted into a locking section of a locking pin. Retrofitting of locking systems which already exist is therefore possible. On its outer circumferential face, the pressure piece can have a thread at least in sections, into which thread it can be introduced into the first receptacle. To this end, the first receptacle has a corresponding section with an internal thread. In addition or as an alternative to this, the pressure piece can have a fastening ring which surrounds the pressure piece from the outside. Via a fastening ring, the pressure piece can be inserted, for example, into an opening which forms the first receptacle, and can be held securely. To this end, the fastening ring can consist, for example, of plastic, in particular of a rubber-like material.

The pressure piece can be of cylindrical configuration and can have an adjusting ring or an adjusting sleeve which has the opening and can be moved in order to set the spacing between the opening and a bottom which lies opposite it. Via the adjusting ring or the adjusting sleeve, it is firstly possible to exchange the spring and the ball or the pressure pin. Secondly, it is possible to change the spacing between the opening and the bottom, the prestress of the ball or of the pressure pin being changed. Via this, changes in the tolerances of a fueling or charging recess can be taken account of. The adjusting ring or the adjusting sleeve are applied as an attachment part to the cylindrical pressure piece and, to this end, have an internal thread, and the pressure piece has an external thread in the connecting region. In further embodiments, however, the pressure piece can also have an internal thread, and the adjusting ring or the adjusting sleeve can have an external thread. The adjusting ring or the adjusting sleeve make it possible, in particular, to set the tolerance compensation individually. Via this, a defined prestress of the ball or pressure pin can be set for each fueling or charging recess.

Here, the diameter of the opening is smaller than the diameter of the ball or of the pressure pin.

Here, the pressure piece can be an integral constituent part of the locking pin or can be received exchangeably in the first receptacle. If the pressure piece is an integral constituent part of the locking pin, it can also be configured, for example, in a first receptacle of the locking pin. Exchangeable receiving of the pressure piece in the locking pin makes, for example, an exchange in the case of damage possible.

The locking pin can have a guide groove, into which a guide element engages. The guide element can be, for example, a constituent part of a central locking unit. The guide groove extends both in the longitudinal direction of the locking pin and in the circumferential direction of the locking pin. Via this, the rotational and translational movement of the locking pin is achieved after the latter is released. At least one section of the guide groove can be configured as a cardioid section, with the result that, in a closed position of a fueling or charging recess, the locking pin maintains its end position. In addition or as an alternative, the locking pin can have a second locking section, from which an element projects or an element engages into an opening. Releasing and locking of the locking pin can take place via this.

Furthermore, the locking pin can be mounted counter to the force of a second spring in a third receptacle. Said spring and the spring of the pressure piece can be configured as compression springs and therefore strive to press the locking pin and the ball or the pressure pin out of the receptacles.

The ball or the pressure pin can consist of a metal, in particular stainless steel or a stainless steel alloy or ceramic. The ball or the pressure pin consists of a material which is resistant to abrasion or some other damage. This ensures that the tolerance compensation is ensured via the pressure piece, even in the case of frequent actuation.

The problem is also solved by way of a fueling or charging recess having one locking device of the above-described variants which additionally has at least one recess body, a lever arm and a fuel filler tube or a charging module, a fuel filler tube or a charging module being inserted into an opening of the recess body, and the lever arm being mounted pivotably, and the locking device being arranged in such a way that, in the closed state of the fueling or charging recess, a ball or a pressure pin of the pressure piece is pressed at least partially via the lever arm into the second receptacle of the pressure piece counter to the force of the spring.

A fueling cover can be arranged on the lever arm. In addition, the fueling or charging recess can have further components. In further embodiments, the fueling or charging recess can have both a fuel filler tube for filling a fuel into a vehicle tank and a charging module such as for example a charging socket. A fueling module can be provided, for example, for filling a fuel tank with a liquid or gaseous fuel. A charging module having a charging socket serves for the electric energy supply of a vehicle energy store.

In the closed state of the fueling or charging module, a tolerance compensation is provided via the pressure piece, with the result that no rattling of a filler cap and/or lever arm occurs in the closed position. As a result of the configuration of the pressure piece, it is subjected to substantially no wear.

A tolerance compensation is provided via this, even in the case of frequent use or actuation of the locking pin and pivoting of the lever arm in order to close the fueling or charging recess.

Further advantages, features and design possibilities result from the following description of the figures of exemplary embodiments which are to be understood to be non-restrictive.

### BRIEF DESCRIPTION OF THE FIGURES

In the drawings:

FIG. 1 shows a perspective illustration of a central locking unit of a fueling or charging recess,

FIG. 2 shows a diagrammatic illustration of a locking device of the central locking unit from FIG. 1,

FIG. 3 shows a diagrammatic sectional view of the locking device from FIG. 2, and

FIG. 4 shows a diagrammatic sectional view of a pressure piece of the locking device from FIG. 2.

Components which are provided with identical designations in the drawings correspond substantially to one another, unless specified otherwise. Moreover, describing constituent parts and showing which are not essential for understanding the technical teaching disclosed herein are dispensed with.

### DETAILED DESCRIPTION OF ONE EXEMPLARY EMBODIMENT

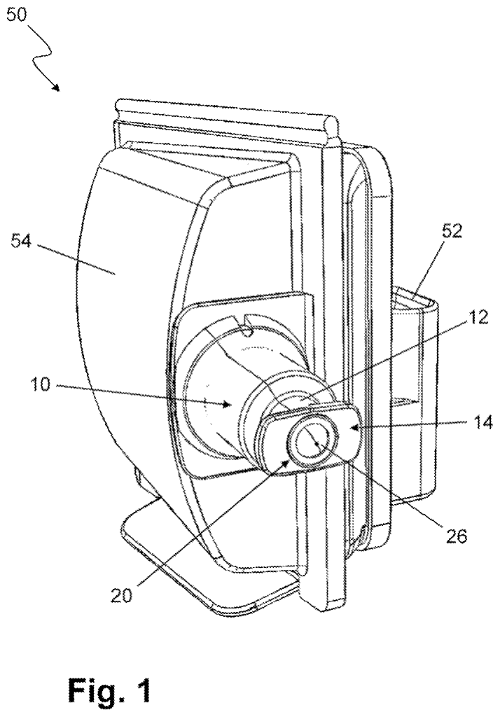

FIG. 1 shows a perspective illustration of a central locking unit 50 of a fueling or charging recess. The central locking unit 50 which is shown in FIG. 1 is configured as a constituent part of a fueling or charging recess. The central locking unit 50 is preferably situated on a section of the fueling or charging recess, which section lies opposite the section, via which a lever arm with a filler cap is mounted pivotably. The lever arm is stressed via a spring device and is held via the central locking unit 50 in the closed state of the fueling or charging recess. The fueling or charging recess has a filler tube and/or a charging module with a charging socket which are/is inserted into an opening of a recess body of the fueling or charging recess. Charging of an energy store with electric current can take place via the charging socket. Liquid or gaseous fuel can be conducted to a vehicle tank via a filler tube.

The fueling devices and the fueling or charging recess with the central locking unit 50 are a constituent part of a vehicle with a corresponding drive. The drive comprises, for example, an internal combustion engine or an electric motor. Furthermore, what are known as hybrid drives can also be provided which have an internal combustion engine and an electric motor. Hybrid drives comprise serial or parallel hybrid drives.

The central locking unit 50 has a housing 54. A spring and a guide element, via which unlocking and locking of the locking pin 12 takes place, are received in the housing 54. The releasing of the locking pin 12 can take place electrically, for example, a connector 52 being provided for this purpose. The central locking unit 50 is situated on a wall section of the recess body.

The configuration of a central locking unit 50 is known in various embodiments from the prior art. An essential feature of a central locking unit 50 is locking of a lever arm and filler cap in the closed state of the fueling or charging recess and releasing the lever arm and the filler cap by way of rotating the locking pin 12 which has a locking section 14 at its front end. The locking pin 12 is part of a locking device 10 which is in turn a constituent part of the central locking unit 50.

In the exemplary embodiment which is shown in FIG. 1, the locking device 10 has a pressure piece 20. The pressure piece 20 is arranged in the locking section 14 and has a ball 26. The ball 26 is pressed out of a second receptacle 22 via a spring 24, the ball 26 being secured against falling out via an opening 28.

The pressure piece 20 serves as a tolerance compensation element, as a result of which no rattling of a lever arm or a filler flap occurs in the closed state of the fueling or charging recess. Conventional systems from the prior art have a resilient end piece on a locking pin for the compensation of tolerances, which end piece consists of a soft component. Abrasion of the soft component occurs on account of the rotational and translational movement of the locking pin. This no longer ensures the tolerance compensation, and rattling of the filler flap and the lever arm occurs.

The locking device 10 which is described herein is subject to substantially no wear, and therefore provides a tolerance compensation even in the case of frequent actuation, which tolerance compensation prevents, for example, rattling of a filler flap or a lever arm.

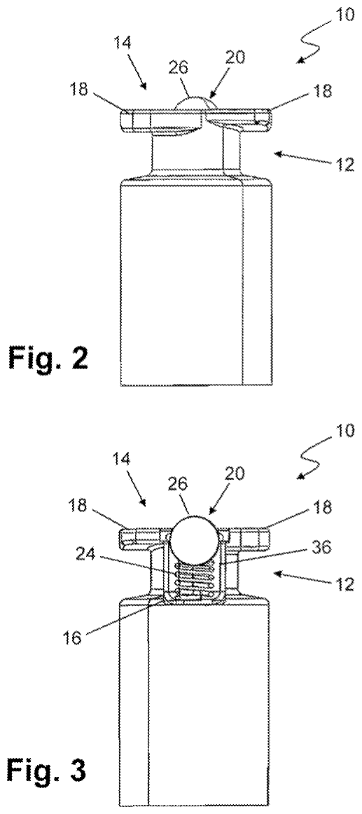

FIG. 2 shows a diagrammatic illustration of a locking device 10 of the central locking unit 50 from FIG. 1. FIG. 1 shows the locking pin 12 with a pressure piece 20 received therein, in a side view. The locking pin 12 has two projecting wings 18 in the locking section 14. In the case of a movement of the locking pin 12, the wings 18 are moved together with the locking pin 12 along its longitudinal axis, and are also rotated about the longitudinal axis. Releasing and locking of the lever arm of a filler flap occur via this.

In the state which is shown in FIG. 2, the ball 26 protrudes by a defined amount out of a second receptacle 22. The state which is shown in FIG. 2 shows the unlocked state.

FIG. 3 shows a diagrammatic sectional view of the locking device 10 from FIG. 2. FIG. 3 likewise shows the unlocked state.

In the locked state, the ball 26 is pressed into the second receptacle 22 counter to the force of a spring 24 via the lever arm of a filler flap. Since the spring 24 strives as a compression spring to press the ball 26 back again into the starting position which is shown in FIGS. 2 and 3, a play of the lever arm which is in contact with the ball 26 is prevented. The lever arm therefore cannot rattle. The lever arm of the filler flap is held securely via the wings 28. A slight play despite the locking via the wings 18 is compensated for via the pressure piece 20 in the above-described way. The pressure piece 20 therefore serves as a tolerance compensation and prevents, for example, rattling noises occurring during driving.

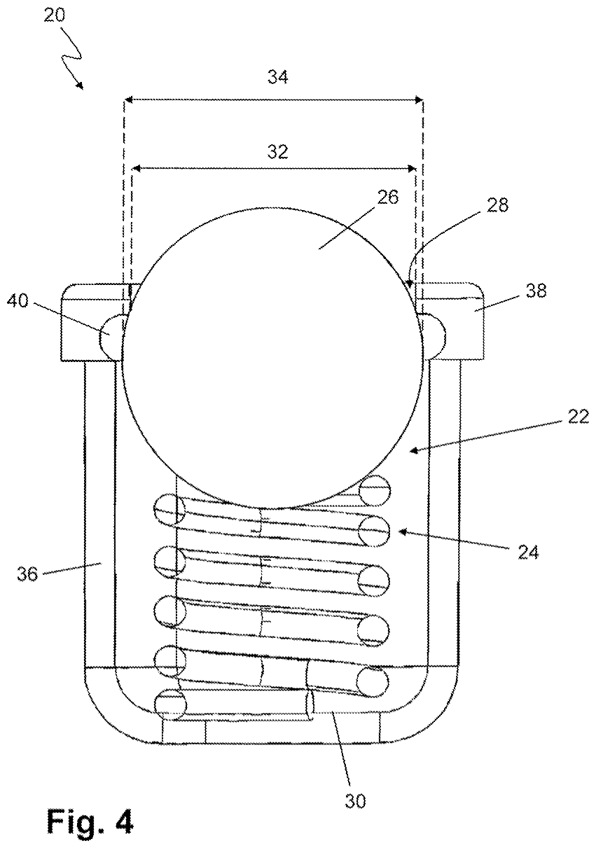

FIG. 4 shows a diagrammatic sectional view of a pressure piece 20 of the locking device 10 from FIG. 2. The pressure piece 20 has a housing 36 which is inserted into a first receptacle 16 in the locking section 14. The housing 36 of the pressure piece 20 can be held securely in the first receptacle 16 by way of a press fit. In addition, the pressure piece 20 can have a fastening ring on the outer circumferential face of the housing 36, which fastening ring additionally holds the housing 36 securely within the first receptacle and prevents it slipping out. In further embodiments, the housing 36 has a thread in sections on its outer circumference, which thread, with a corresponding thread of the first receptacle 16, makes it possible for the pressure piece 20 to be screwed into the first receptacle 16.

The spring 24 is supported against the bottom 30 in the second receptacle 22. The opposite end of the spring 24 is supported on the ball 26. The ball 26 has a greater diameter 34 than the diameter 32 of the opening 28 in a ring 38 of the pressure piece 20. In addition, a groove 40 is situated in the region of the opening 28, the lower diameter of which groove 40 is greater than the diameter 32 of the opening 28. The ball 26 can therefore protrude out of the opening 28, as shown in FIG. 4.

FIG. 4 shows an unlocked state. In the locked state, the ball 26 is pressed via the lever arm into the receptacle 22. The configuration of the pressure piece 20 with a ball 26 allows it to be possible, in particular, for the ball 26 to be rotated on account of the translational and rotational movement of the locking pin 12, without abrasion occurring. To this end, the ball 26 consists of a metal, in particular stainless steel or a stainless steel alloy. In further embodiments, the ball 26 can also consist of a ceramic.

In addition, the ring 38 is situated on the housing 36, which ring 38 can be configured in further embodiments as an adjusting ring with an internal thread. In the upper region, the housing 36 has a corresponding thread. It is possible via the adjusting ring 38 for the spacing of the ball 26 from the bottom 30 of the housing 36 to be changed. Via this, a changed prestress of the ball 26 can be achieved. In addition, it is possible via this for the pressure piece 20 to be adapted to various tolerances in the case of a fueling or charging recess. Furthermore, the configuration of the ring 38 as an adjusting ring in further embodiments allows removal of the ring 38, with the result that both the ball 26 and the spring 30 can be exchanged or the second receptacle 22 can be cleaned.

Conventional systems from the prior art have damping members for the compensation of tolerances, which damping members are subject to high wear on account of the rotational and translational movement. A ball 26 made from ceramic or a metal is not subject to any wear of this type, and even permits a rotation. Via this, a tolerance compensation is provided which is configured with a long service life and is subject to substantially no wear. In addition, melting of soft components does not occur even at high temperatures, as can occur in the prior art, for example. Furthermore, a ball 26 made from a ceramic or a metal is resistant to fuels and fuel vapors. Therefore, the ball 26 cannot be corroded by way of fuels or vapors.

In further embodiments, the central locking unit 50 can have an emergency unlocking means which makes a rotation of the locking pin 12 via a cable pull possible. This ensures that unlocking occurs if, for example, the electric components fail.

The actuation of a locking pin 12 with a slotted guide for the rotational and translational movement, a rotation of the locking section 14 occurring, is known in various embodiments from the prior art. Reference is accordingly made thereto with respect to triggering of an unlocking action and with respect to locking.

### LIST OF DESIGNATIONS

10 Locking device
12 Locking pin
14 Locking section
16 First receptacle
18 Wing
20 Pressure piece
22 Second receptacle
24 Spring
26 Ball
28 Opening
30 Bottom
32 Diameter
34 Diameter
36 Housing
38 Ring
40 Groove
50 Central locking unit
52 Connector
54 Housing

1. A locking device for fueling or charging recesses, having a locking pin which has a locking section at one end and can be moved translationally and rotationally for locking purposes, the locking pin having a pressure piece on the locking section, the pressure piece having a second receptacle, in which a spring and a ball or a pressure pin are arranged, and the ball or the pressure pin are pressed via the spring against an opening of the second receptacle of the pressure piece.

2. The locking device as claimed in claim 1, the locking pin having a first receptacle on the locking section, in which first receptacle the pressure piece is received.

3. The locking device as claimed in claim 1, the pressure piece being of cylindrical configuration and having an adjusting ring or an adjusting sleeve which has the opening and can be moved in order to set the spacing between the opening and a bottom which lies opposite it.

4. The locking device as claimed in claim 1, the diameter of the opening being smaller than the diameter of the ball or of the pressure pin.

5. The locking device as claimed in claim 1, the pressure piece being an integral constituent part of the locking pin or being received exchangeably in the first receptacle.

6. The locking device as claimed in claim 1, the locking pin having a guide groove, into which a guide element engages.

7. The locking device as claimed in claim 6, the locking pin being mounted counter to the force of a second spring in a third receptacle.

8. The locking device as claimed in claim 1, the ball or the pressure pin consisting of stainless steel, a stainless steel alloy or ceramic.

9. A fueling or charging recess having at least one locking device as claimed in claim 1, a recess body, a lever arm and a fuel filler tube or a charging module, the fuel filler tube or the charging module being inserted into an opening of the recess body, and the lever arm being mounted pivotably, and the locking device being arranged in such a way that, in the closed state of the fueling or charging recess, the ball or the pressure pin of the pressure piece is pressed at least partially via the lever arm into the second receptacle of the pressure piece counter to the force of the spring.
